(19) United States
(12) Patent Application Publication
(10) Pub. No.: US 2024/0391584 A1
(43) Pub. Date: Nov. 28, 2024

(54) COUNTER-FLOW POINT EMBEDDED ELECTRODE FOR DYNAMIC STALL CONTROL

(71) Applicant: University of Florida Research Foundation, Inc., Gainesville, FL (US)

(72) Inventors: Subrata Roy, Gainesville, FL (US); Alexander Lilley, Gainesville, FL (US); Miguel Visbal, Gainesville, FL (US)

(21) Appl. No.: 18/669,673

(22) Filed: May 21, 2024

Related U.S. Application Data
(60) Provisional application No. 63/540,467, filed on Sep. 26, 2023.
(60) Provisional application No. 63/504,107, filed on May 24, 2023.

(51) Int. Cl. B64C 23/00; H05H 1/24

(52) U.S. Cl. CPC B64C 23/005; H05H 1/2439; B64C 2230/12

(57) ABSTRACT

The present disclosure presents systems and methods for dynamic stall control in aircrafts. One such method involves positioning one or more counter-flow point embedded electrode plasma actuator devices on an edge of an airfoil of an aircraft, wherein a counter-flow point embedded electrode plasma actuator device comprises at least a first electrode that is unexposed and embedded under a surface of the airfoil and a second electrode positioned on or in a top surface of the airfoil; and/or activating the one or more counter-flow point embedded electrode plasma actuator devices during a flight of the aircraft, wherein a dynamic stall angle of a pitching airfoil is increased during the flight of the aircraft by forcing plasma over the edge of the pitching airfoil.

### CROSS-REFERENCE TO RELATED APPLICATION

This application claims priority to co-pending U.S. provisional application entitled, “Counter-Flow Point Embedded Electrode for Dynamic Stall Control,” having application No. 63/540,467, filed Sep. 26, 2023, and co-pending U.S. provisional application entitled, “Counter-Flow Point Embedded Electrode for Dynamic Stall Control,” having application No. 63/504,107, filed May 24, 2023, each of which is entirely incorporated herein by reference.

### STATEMENT REGARDING FEDERALLY SPONSORED RESEARCH OR DEVELOPMENT

This invention was made whole or in part from funding received under Grant No. FA8650-16-C-2644, by the United States Air Force Research Laboratory, through a subaward from the Ohio Aerospace Institute.

### BACKGROUND

Dynamic stall is a phenomenon that occurs for rapidly pitching airfoils. It is of specific interest in the case of helicopters which use cyclic airfoil pitching to control the direction of flight, where dynamic stall limits the maximum velocity of helicopters. The use of plasma actuators for delay of dynamic stall is not new, but recent success using high frequency plasma actuators has revived interest. Plasma actuators function by having large voltage differential across two electrodes. One electrode is embedded in a dielectric, and one is exposed to atmosphere. The configuration may have more than one embedded electrode or no exposed electrodes. Variations of the plasma actuators use large embedded electrodes which struggle to create forcing around high curvature surfaces.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A shows an operational arrangement of an exemplary Linear Counter-flow Point Embedded Electrode (LCPEE) using an exposed electrode and a single embedded electrode on the leading edge of an airfoil in accordance with the present disclosure.

FIG. 1B shows an airfoil undergoing sinusoidal motion between 4 and 18 degrees angle of attack at a reduced frequency of 0.19 without an actuator being on in accordance with the present disclosure.

FIG. 1C. shows the airfoil undergoing sinusoidal motion with the actuator being on where no flow reversal occurs and dynamic stall does not occur in accordance with the present disclosure.

FIG. 2 depicts an exemplary configuration of an exemplary Multiple Linear Counter-flow Point Embedded Electrode (MLCPEE) where different phase alternating current signals are applied to the electrodes in accordance with various embodiments of the present disclosure.

FIG. 3 depicts an exemplary configuration of a MLCPEE, where different phase alternating current signals are applied to the electrodes and no electrodes are exposed to the atmosphere in accordance with various embodiments of the present disclosure.

FIG. 4 depicts an exemplary configuration of a MLCPEE of FIG. 3, where the orientation of forcing may be configured such that the forcing occurs toward the peak of curvature.

FIG. 5 depicts an exemplary configuration of the MLCPEE of FIG. 3, where the orientation of forcing may be configured such that the forcing occurs away from the high curvature region.

FIG. 6 shows a cut away of an embodiment of the LCPEE with spatially varying electrodes in accordance with various embodiments of the present disclosure.

FIG. 7 shows a digital image of an LCPEE using an exposed electrode and a point embedded electrode on a leading edge of an airfoil with the exposed electrode having a sinusoidal serpentine geometry in accordance with various embodiments of the present disclosure.

FIG. 8 shows a digital image of an LCPEE using an exposed electrode and a point embedded electrode on a leading edge of an airfoil with the exposed electrode having a sinusoidal serpentine geometry covering a region beyond the leading edge of the airfoil in accordance with various embodiments of the present disclosure.

### DETAILED DESCRIPTION

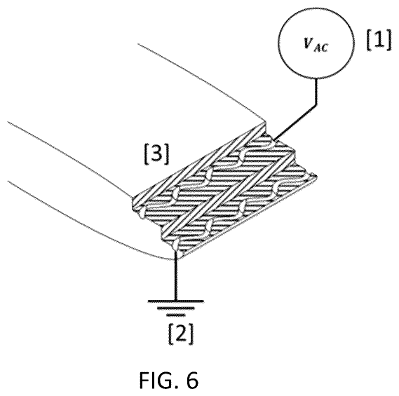

In accordance with various embodiments of the present disclosure, a counter-flow point embedded electrode plasma actuator device serves the purpose of extending or forcing plasma over highly curved geometries and can be used in plasma systems and related methods to increase dynamic stall angles in accordance with various embodiments of the present disclosure. In various embodiments, the embedded electrode may be linear or may be non-uniform spatially and vary in geometry to generate three-dimensional (3D) forcing (FIG. 6). The geometric spatial variation may be square, sinusoidal, triangular or another form. The geometric wavelength may be changed for different application(s). The forcing will spatially vary due to the geometric variations of electrodes.

The following figures are not necessarily drawn to scale. For the present disclosure, the illustrations of the counter-flow point embedded electrode plasma actuator device are designed with a leading edge of an airfoil in mind. However, the present disclosure and its applications are not limited to the leading edge of an airfoil, but to the general application where it is necessary to provide forcing over a curved surface. The forcing occurs through the Lorentz force.

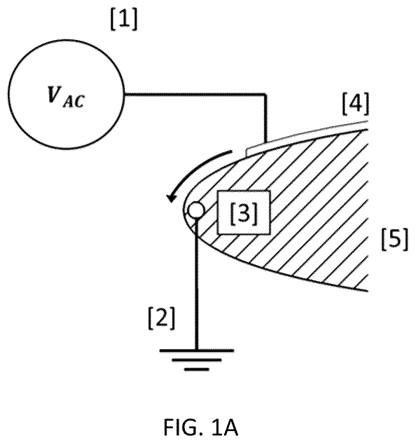

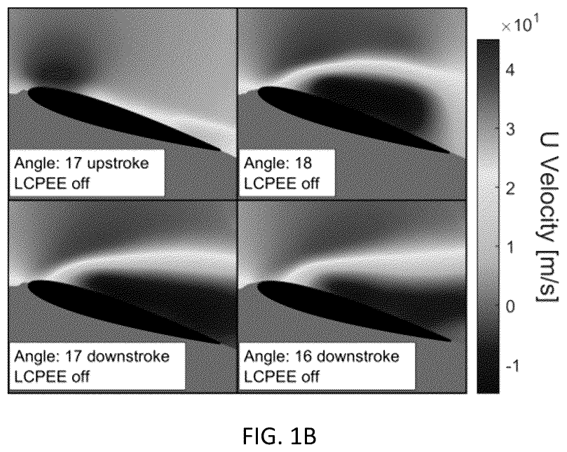

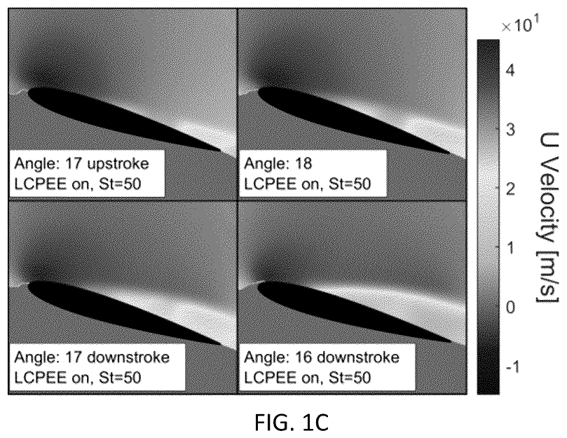

FIG. 1A shows an operational arrangement of an exemplary Linear Counter-flow Point Embedded Electrode (LCPEE) plasma actuator device using an exposed electrode and a single embedded electrode on the leading edge of a NACA 0012 airfoil. As such, FIGS. 1A and FIGS. 2-5 that follow depict different configurations for the LCPEE, in accordance with various embodiments of the present disclosure. In accordance with the figures and the varying configurations, plasma forms between the electrodes depending on the signal applied and its phase shift.

In FIG. 1A, a high voltage alternating current source [1] and a ground terminal [2] are shown. Elements [1] and [2] may or may not be switched. The figure further depicts a spanwise embedded electrode [3], an exposed electrode [4], and a dielectric substrate [5], depicted by hatch marks.

In FIG. 1A, a standard LCPEE configuration is shown, where the wing depicted as hatch marks, functions as the dielectric for this depiction. However, in accordance with the present disclosure, the airfoil does not need to be the dielectric. For some applications, the dielectric may be a separate entity from the airfoil body. Forcing occurs from the exposed dielectric to the embedded dielectric. The applied input voltage signal may range in frequency, magnitude, or in waveform. Waveforms may be sinusoidal, triangular, sawtooth, square, and other waveforms. The ground and applied voltage may be interchanged between electrodes. FIG. 1B shows an airfoil undergoing sinusoidal motion between 4 and 18 degrees angle of attack at a reduced frequency of 0.19 without the actuator being on. FIG. 1C. shows the actuator-on case where no flow reversal occurs and dynamic stall does not occur.

In FIG. 1B, wind tunnel particle image velocimetry data shows the U velocity of the flow during a sinusoidal pitching motion with the LCPEE being turned off. This is the configuration depicted in FIG. 1A.

In FIG. 1C, wind tunnel particle image velocimetry data shows the U velocity of the flow during a sinusoidal pitching motion. The LCPEE is turned on at 30,000 Hz (Strouhal number=50). This is the configuration depicted in FIG. 1A.

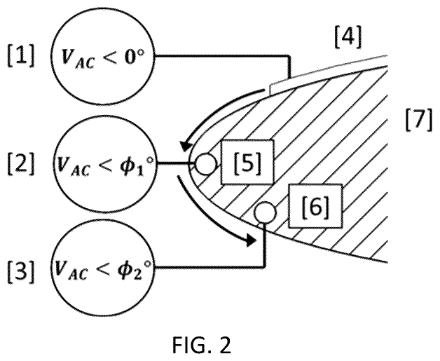

FIG. 2 depicts an alternate configuration for a Multiple Linear Counter-flow Point Embedded Electrode (MLCPEE) plasma actuator device where different phase alternating current signals are applied to the electrodes. In this case, a single exposed electrode is exposed to atmosphere. Three signals are applied with phase difference such that forcing occurs over the entire curved surface. The signals may be evenly distributed in phase or not.

For FIG. 2, one embodiment of the MLCPEE arrangement uses an exposed electrode [4] and two embedded electrodes [5], [6] on the leading edge of a NACA 0012 airfoil. In the figure, different phase alternating current signals [1], [2], [3] are applied with a high voltage alternating current source [1] being applied to the exposed electrode [4], a phase shifted high voltage alternating current source [2] being applied to a first spanwise embedded electrode [5], and a phase shifted high voltage alternating current source [3] being applied to a second spanwise embedded electrode [6]. The figure further depicts a dielectric substrate [7], depicted by hatch marks.

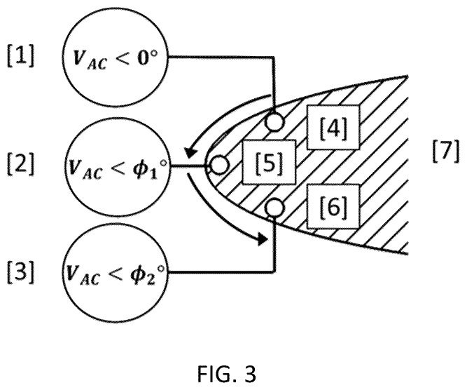

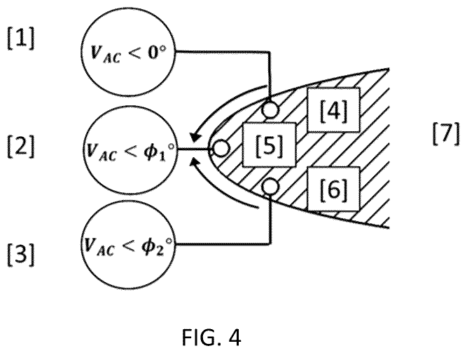

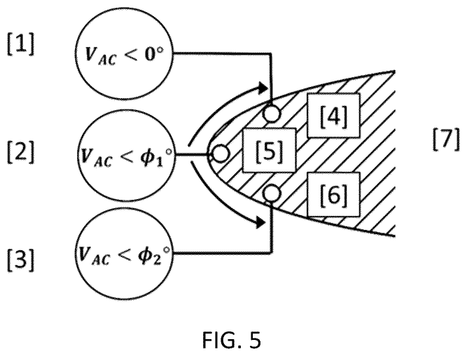

FIG. 3 depicts an alternate configuration of the MLCPEE, where different phase alternating current signals are applied to the electrodes. In this configuration, no electrodes are exposed to the atmosphere. High voltage overcomes the dielectric locally inducing ionization. Phase of the signals may be evenly spaced or not. The orientation of forcing may be reversed such that forcing occurs in the clockwise direction. The signal may be configured such that the forcing occurs toward the peak of curvature (FIG. 4). The signal may be altered such that the forcing occurs away from the high curvature region (FIG. 5).

In an exemplary embodiment of FIG. 4, the MLCPEE uses three embedded electrodes on the leading edge of a NACA 0012 airfoil. Forcing occurs toward the high curvature region. The figure shows a high voltage alternating current source [2], phase shifted high voltage alternating current sources [2], [3], and spanwise embedded electrodes [4], [5], [6]. The figure further includes a dielectric substrate, depicted by hatch marks.

In an exemplary embodiment of FIG. 5, the MLCPEE uses three embedded electrodes on the leading edge of a NACA 0012 airfoil. Forcing occurs away from the high curvature region. The figure shows a high voltage alternating current source [1], phase shifted high voltage alternating current sources [2], [3], and spanwise embedded electrodes [4], [5], and [6]. The figure further includes a dielectric substrate [7], depicted by hatch marks.

In an exemplary embodiment of FIG. 6, the figure shows a cut away of an embodiment of the LCPEE with spatially varying electrodes. In particular, the figure shows the high voltage alternating current source [1] and a ground terminal [2], where elements [1] and [2] may or may not be switched. The figure further shows spanwise varying 3D embedded electrodes [3], with the dielectric substrate depicted by hatch marks.

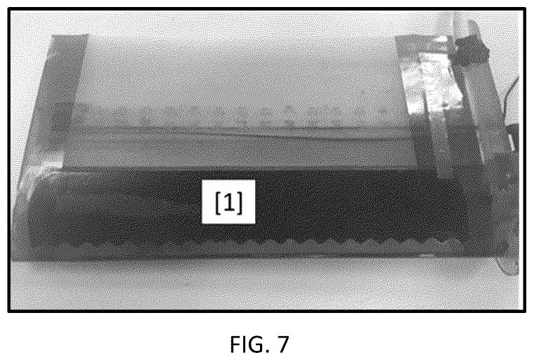

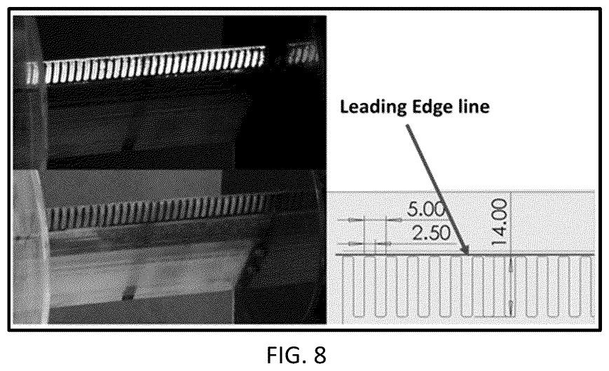

To further expand on this concept of spanwise geometric variation, the exposed electrode does not need to have a linear geometry. The exposed electrode geometry may be square, sinusoidal, triangular or another form. The embedded electrode may take on a linear, square, sinusoidal, triangular or another form (FIG. 7), which may be referred to as a Sinusoidal/Square Counter-flow Point Embedded Electrode (SCPEE) plasma actuator device. The geometry may be large and cover much of the leading edge such as in (FIG. 8).

Referring back to FIG. 7, the figure shows an example of a geometry that varies in the spanwise direction. Here, a digital photographic image of a sinusoidal serpentine geometry with a point embedded electrode is presented, with the exposed sinusoidal electrode [1] being shown in black. Correspondingly, FIG. 8 shows an example of a spanwise geometric actuator that covers a region beyond the leading edge.

In one or more aspects for various embodiments, one or more airfoils comprise at least one blade of a rotary-wing aircraft; and/or the one or more airfoils comprise at least one wing of a fixed-wing aircraft.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A method comprising:
positioning one or more counter-flow point embedded electrode plasma actuator devices on an edge of an airfoil of an aircraft, wherein a counter-flow point embedded electrode plasma actuator device comprises at least a first electrode that is unexposed and embedded under a surface of the airfoil and a second electrode positioned on or in a top surface of the airfoil; and
activating the one or more counter-flow point embedded electrode plasma actuator devices during a flight of the aircraft, wherein a dynamic stall angle of a pitching airfoil is increased during the flight of the aircraft by forcing plasma over the edge of the pitching airfoil.

2. The method of claim 1, wherein the edge of the airfoil is a leading edge of the airfoil.

3. The method of claim 1, wherein the second electrode comprises a single unexposed embedded electrode.

4. The method of claim 1, wherein the one or more counter-flow point embedded electrode plasma actuator devices comprise a multiple counter-flow point embedded electrode plasma actuator device, wherein the second electrode comprises an unexposed embedded electrode, wherein the multiple counter-flow point embedded electrode plasma actuator device, further comprises an additional unexposed embedded electrode.

5. The method of claim 1, wherein the one or more counter-flow point embedded electrode plasma actuator devices are activated by application of an input voltage signal having a sinusoidal waveform.

6. The method of claim 1, wherein the one or more counter-flow point embedded electrode plasma actuator devices are activated by application of an input voltage signal having a triangular waveform.

7. The method of claim 1, wherein the one or more counter-flow point embedded electrode plasma actuator devices are activated by application of an input voltage signal having a square waveform.

8. The method of claim 1, wherein the one or more counter-flow point embedded electrode plasma actuator devices are activated by application of an input voltage signal having a sawtooth waveform.

9. The method of claim 1, wherein the one or more counter-flow point embedded electrode plasma actuator devices are activated by application of different phase alternating current signals to the first electrode and the second electrode.

10. The method of claim 1, wherein the airfoil is formed of a dielectric material.

11. The method of claim 1, further comprising attaching a dielectric material to the airfoil, wherein the dielectric material is positioned between the first electrode and the second electrode.

12. The method of claim 1, wherein a geometric shape of the first electrode is linear.

13. The method of claim 1, wherein a geometric shape of the first electrode varies spatially.

14. The method of claim 13, wherein the geometric shape of the first electrode comprises a square.

15. The method of claim 13, wherein the geometric shape of the first electrode comprises a sinusoid.

16. The method of claim 13, wherein the geometric shape of the first electrode is triangular.

17. A system comprising:
one or more airfoils of an aircraft;
one or more counter-flow point embedded electrode plasma actuator devices attached to an edge of an airfoil of the aircraft, wherein a counter-flow point embedded electrode plasma actuator device comprises at least a first electrode that is unexposed and embedded under a surface of the airfoil and a second electrode positioned on or in a top surface of the airfoil;
one or more voltage sources coupled to the one or more counter-flow point embedded electrode plasma actuator devices, wherein the one or more voltage sources are configured to activate the one or more counter-flow point embedded electrode plasma actuator devices during a flight of the aircraft, wherein a dynamic stall angle of a pitching airfoil is increased during the flight of the aircraft by forcing plasma over the edge of the pitching airfoil.

18. The system of claim 17, wherein the edge of the airfoil is a leading edge of the airfoil.

19. The system of claim 17, wherein the one or more counter-flow point embedded electrode plasma actuator devices comprise a linear counter-flow point embedded electrode plasma actuator device, wherein the second electrode comprises a single unexposed embedded electrode.

20. The system of claim 17, wherein the one or more counter-flow point embedded electrode plasma actuator devices comprise a multiple counter-flow point embedded electrode plasma actuator device, wherein the second electrode comprises an unexposed embedded electrode, wherein the multiple counter-flow point embedded electrode plasma actuator device, further comprises an additional unexposed embedded electrode.

21. The system of claim 17, wherein the one or more counter-flow point embedded electrode plasma actuator devices are activated by application of an input voltage signal having a sinusoidal waveform, a triangular waveform, a square waveform, or a sawtooth waveform.

22. The system of claim 17, wherein one or more voltage sources are configured to apply different phase alternating current signals to the first electrode and the second electrode.

23. The system of claim 17, wherein the airfoil is formed of a dielectric material.

24. The system of claim 17, wherein a geometric shape of the first electrode is linear.

25. The system of claim 17, wherein a geometric shape of the first electrode varies spatially.
